(19) United States
(12) Patent Application Publication
(10) Pub. No.: US 2007/0201569 A1
(43) Pub. Date: Aug. 30, 2007

(54) Apparatus, method and computer program product providing joint detection for increasing throughout with data in uplink that multiplexes users using codes and that multiplexes users using frequency multiplexing

(75) Inventors: Kari Pajukoski, Oulu (FI); Esa Tiirola, Kempele (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/703,943

(22) Filed: Feb. 8, 2007

Related U.S. Application Data
(60) Provisional application No. 60/771,929, filed on Feb. 8, 2006.

(51) Int. Cl. H04K 1/10

(52) U.S. Cl. 375/260

(57) ABSTRACT

First information is detected in a received wideband signal. The first information is conveyed by a plurality of multiplexed frequency bands, individual ones of the multiplexed frequency bands corresponding to individual ones of first users and to a transport format. Detecting includes making data decisions corresponding to the first information. For each first user, a regenerated signal is created using the data decisions corresponding to that first user and the transport format. A resultant signal is created based on the regenerated signals for all of the first users and on the received wideband signal. Second information is detected in the resultant signal at least by using a number of spreading codes, individual ones of which are associated with individual ones of second users.

### CROSS-REFERENCE TO RELATED APPLICATIONS

The present application claims the benefit under 35 U.S.C. §119(e) of U.S. Provisional Patent Application No. 60/771,929, filed on 8 Feb. 2006, the disclosure of which is hereby incorporated by reference in its entirety.

### TECHNICAL FIELD

The exemplary and non-limiting embodiments of this invention relate generally to wireless communications systems, methods and devices and, more specifically, relate to uplink transmissions from a user equipment to a base station in a system that uses codes to multiplex users.

### BACKGROUND

The following abbreviations are herewith defined:

| | |
|---|---|
| CDMA | code division multiple access |
| CP | cyclic prefix |
| DPCCH | dedicated physical control channel |
| DS | direct spread |
| FBI | feedback information |
| FDMA | frequency division multiple access |
| FDPA | frequency division pilot access |
| HARQ | hybrid automatic repeat request |
| HSUPA | high speed uplink packet access |
| IFDMA | interleaved FDMA |
| IC | interference cancelling |
| IRC | interference rejection combining |
| LMMSE | linear minimum mean squared error |
| LTE | long term evolution |
| MIMO | multiple input, multiple output |
| MPIC | multipath PIC |
| PAR | peak-to-average power ratio |
| PC | power control |
| PIC | parallel interference cancellation |
| QPSK | quadrature phase shift keying |
| SC | single carrier |
| SW | software |
| TFCI | transport format combination indicator |
| TPC | transmission power control |
| TTI | transmission time interval |
| UE | user equipment |
| UL | uplink |
| UMTS | universal mobile telecommunication system |
| UTRAN | UMTS terrestrial radio access network |
| VoIP | voice over internet protocol |
| VSCRF | variable spreading and chip repetition factors |
| WCDMA | wideband CDMA |

A problem exists in that the WCDMA (HSUPA) transport format is not particularly suitable for use at high data rates. Further, equalization problems exist with high modulation orders even with advanced receivers such as LMMSE and MPIC. Further, a Rake receiver does not work at all in a severe multipath channel with 16QAM. There is also a PAR problem with the use of multicodes.

An additional problem that arises relates to WCDMA and HSUPA in that the system is interference limited as the simultaneous users interfere with one another. The only practical conventional technique to orthogonalize different users in WCDMA and HSUPA is to utilize complex IC receivers. However, the use of practical IC receivers is not optimum from at least an implementation and complexity perspective.

In the current implementation of the UL, different users are separated using spreading codes and, as a result, they are completely non-orthogonal (being non-synchronized at the BS receiver and/or having experienced frequency selective channel). The interference is suppressed by the use of spreading codes. In next generation systems such as UTRAN LTE and WiMax FDMA access between users has been proposed. Capacity gains of the order of 100 to 200 percent for UTRAN LTE, as compared to HSUPA, have been shown.

On the other hand it has been shown that by using an optimal IC receiver WCDMA could provide almost similar performance figures as the UTRAN LTE. However, and as was noted above, the complexity of optimal IC receivers makes their use in a practical system less than optimum. In an orthogonal system such as UTRAN LTE one drawback to the use of IC receiver, as compared to non-orthogonal systems, is the increased amount of control information that needs to be transmitted over the wireless link, as the time varying orthogonal resources need to be frequently signaled to each UE. The overhead of this control information can become significant if there are multiple simultaneous real time or almost real time users, such as VoIP users.

In general, it can be shown that advanced receivers such as the IC and IRC do not provide a very significant gain in the WCDMA UL due to the large number of simultaneous users.

A problem with the IC receiver is that the complexity increases significantly if there are several users to be cancelled. The implementation complexity of an optimal interference canceller (see, for example, third generation partnership project (3GPP) technical report (TR) 25.814, “Physical Layer Aspects for Evolved UTRA”) is an exponential function of the number of users, and as a consequence it is not feasible for most practical receivers. Also, the efficiency of practical PIC is better when there are very few high bit rate interferers to be cancelled, as opposed to a large number of low bit rate interferers, e.g., 64 to 384 kbit/s users.

With the IRC receiver the problem is that the large numbers of low data rate users (e.g., speech users) tend to make the interference appear to be spatially white. The best performance with the IRC receiver is obtained when the interference is spatially colored, e.g., with a single very high bit rate interferer. However, this is not a typical interference scenario in the WCDMA UL. In addition, with the IRC receiver the number of signals that can be rejected depends on the number of receiving antennas in such a way that N−1 complex interferers can be nulled with N receiving antennas.

### BRIEF SUMMARY

In an exemplary embodiment, a method is disclosed that includes detecting first information in a received wideband signal. The first information is conveyed by a plurality of multiplexed frequency bands, individual ones of the multiplexed frequency bands corresponding to individual ones of first users and to a transport format. Detecting includes making data decisions corresponding to the first information. For each first user, a regenerated signal is created using the data decisions corresponding to that first user and the transport format. A resultant signal is created based on the regenerated signals for all of the first users and on the received wideband signal. Second information is detected in the resultant signal at least by using a number of spreading codes, individual ones of which are associated with individual ones of second users.

In another exemplary embodiment, a computer program product tangibly embodies a program of machine-readable instructions executable by at least one data processor to perform operations. The operations include detecting first information in a received wideband signal, the first information conveyed by a plurality of multiplexed frequency bands, individual ones of the multiplexed frequency bands corresponding to individual ones of first users and to a transport format. Detecting includes making data decisions corresponding to the first information. The operations include, for each first user, creating a regenerated signal using the data decisions corresponding to that first user and the transport format, and creating a resultant signal based on the regenerated signals for all of the first users and on the received wideband signal. The operations include detecting second information in the resultant signal at least by using a plurality of spreading codes, individual ones of which are associated with individual ones of second users.

In a further exemplary embodiment, an apparatus includes a first detector configured to detect first information in a received wideband signal, the first information conveyed by a plurality of multiplexed frequency bands. Individual ones of the multiplexed frequency bands correspond to individual ones of first users and to a transport format. The first detector is configured, during detection, to make data decisions corresponding to the first information. The apparatus includes a regeneration module configured, for each first user, to create a regenerated signal using the data decisions corresponding to that first user and the transport format. The apparatus includes a device configured to create a resultant signal based on the regenerated signals for all of the first users and on the received wideband signal. The Applicant also includes a second detector configured to detect second information in the resultant signal at least by using a plurality of spreading codes, individual ones of which are associated with individual ones of second users.

In an additional exemplary embodiment, an apparatus includes means for detecting first information in a received wideband signal. The first information is conveyed by a plurality of multiplexed frequency bands. Individual ones of the multiplexed frequency bands correspond to individual ones of first users and to a transport format. The means for detecting first information is configured, during detection, to make data decisions corresponding to the first information. The apparatus also includes means for creating, for each first user, a regenerated signal using the data decisions corresponding to that first user and the transport format. The apparatus further includes means for creating a resultant signal based on the regenerated signals for all of the first users and on the received wideband signal. The apparatus additionally includes means for detecting second information in the resultant signal at least by using a plurality of spreading codes, individual ones of which are associated with individual ones of second users.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 shows a comparison for WCDMA using a LMMSE chip equalizer and Cyclic Single Carrier transmission using a frequency domain equalizer, for a single user case, a 0.5 TTI, two receive antennas, QPSK, 16 QAM modulation and power control turned off.

FIG. 2A shows the structure of one timeslot in accordance with the cyclic transport format. .

FIG. 2B illustrates a frequency domain representation of the cyclic transport format in relation to WCDMA HSUPA signals within a 5 MHz frequency band.

FIG. 2C shows a time domain representation of the cyclic transport format and the WCDMA transmission scheme.

FIG. 2D shows the cyclic transport format combined with the DPCCH of WCDMA.

FIG. 3 shows an example related to realizing orthogonal multiple access between the UEs using the cyclic transport format for a FDPA-DS-CDMA embodiment herein.

FIG. 4A shows an example related to realizing orthogonal multiple access between the UEs using the cyclic transport format for an IFDMA embodiment.

FIG. 4B shows an exemplary result of using the symbol repetition and compression FIG. 4A after modulation (e.g., spreading) using user-specific phase vectors for two users.

FIG. 4C shows an exemplary result of using the symbol repetition and compression FIG. 4A after modulation using user-specific phase vectors for a single user.

FIG. 5 is a simplified block diagram of an UL receiver that is suitable for use with the cyclic transport format in accordance with exemplary embodiments of this invention.

FIG. 6A shows a performance example assuming the conditions listed in the Table of FIG. 6B.

FIG. 7 depicts a performance example of the cyclic transport format in accordance with exemplary embodiments of this invention in the context of IRC.

FIG. 8 shows a simplified block diagram of various electronic devices that are suitable for use in practicing the exemplary embodiments of this invention.

FIG. 9 shows a flowchart of an exemplary method to realize the orthogonal multiple access between UEs using the cyclic transport format, and to transmit spread and mapped data, as shown in FIG. 3.

FIG. 10 shows an exemplary transmitter suitable for generating cyclic transport format data as described in reference to FIG. 3 and also suitable for generating WCDMA data and for transmitting the generated data.

FIG. 11 shows a flowchart of an exemplary method to realize the orthogonal multiple access for UEs using the cyclic transport format, and to transmit data, of FIGS. 4A-4C.

FIG. 12 shows an exemplary transmitter suitable for generating cyclic transport format data as described in reference to FIGS. 4A-4C and also suitable for generating WCDMA data and for transmitting the generated data.

FIG. 13 shows a flowchart of an exemplary method for a UE to transmit using either WCDMA or a cyclic transport format described herein.

FIG. 14 is a flowchart for despreading data transmitted using the techniques of FIGS. 3 and 9.

FIG. 15 is a flowchart for despreading data transmitted using the techniques of FIGS. 4A-4C and 11.

FIG. 16 is a flowchart of a method for creating and transmitting data using either a WCDMA transport format or cyclic transport format.

FIG. 17 is a logic flow diagram in accordance with the exemplary embodiments of this invention.

FIG. 18 is a simple block diagram of a receiver for performing joint detection of a WCDMA transport format and a cyclic transport format using IFDMA.

### DETAILED DESCRIPTION OF EXEMPLARY EMBODIMENTS

The exemplary embodiments of this invention relate to and further enhance the invention disclosed in copending U.S. Patent Application No.: ______, filed on even date herewith, by Esa Tiirola and Kari Pajukoski, entitled “Apparatus, Method and Computer Program Product Providing A Transport Format That Is Compatible With Another Transport Format That Uses Spreading Codes” (attorney's docket no.: 897A.0028.U1(US)), which is incorporated by reference herein and referred to below for convenience as the “copending Patent Application”.

The exemplary embodiments of the invention disclosed in the copending Patent Application provide solutions to at least some of the foregoing problems through the use of a cyclic transmission format compatible with the WCDMA UL. The cyclic transmission format allows the usage of a simple frequency domain equalizer at the receiver, which is robust in the presence of Inter-Path Interference, and also offers enhanced performance with high data rates. In addition, the use of multicodes can be avoided with the use of the cyclic transmission format in the WCDMA UL.

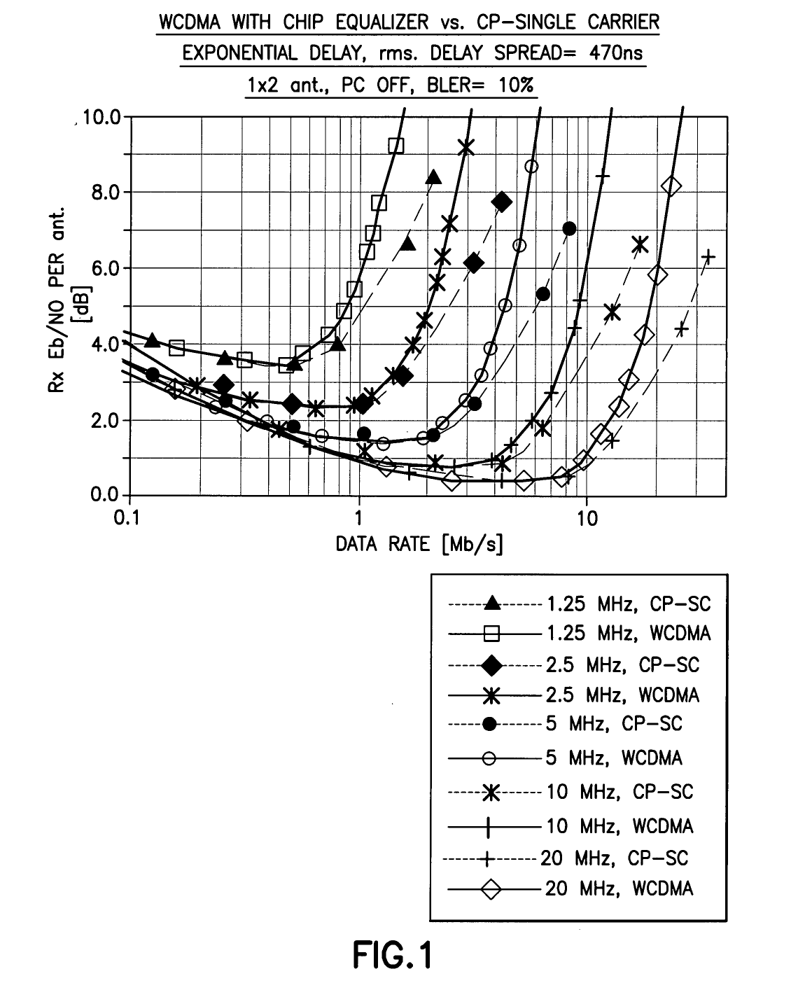

It is noted that a cyclic transport format is known (e.g., in a single carrier transmission). A cyclic transport format allows the use of simple frequency domain equalizer, which is resistive against Inter Path Interference and offers high performance with high data rates. This can be seen in FIG. 1 which compares the Eb/No performance of WCDMA using a complex time domain LMMSE chip equalizer and a cyclic single carrier transmission using a simpler frequency domain equalizer.

The exemplary embodiments of this invention are directed at least in part to the third generation UL evolution based on WCDMA (HSUPA). An exemplary goal is to ensure that the UL performance of the WCDMA evolution is competitive against competing technologies such as WiMax, Flarion, 3GPP2 evolution and UTRAN LTE. To this end, herein disclosed are an exemplary cyclic transport format and exemplary spreading and mapping techniques that use the cyclic transport format and that enable contemporaneous use of WCDMA.

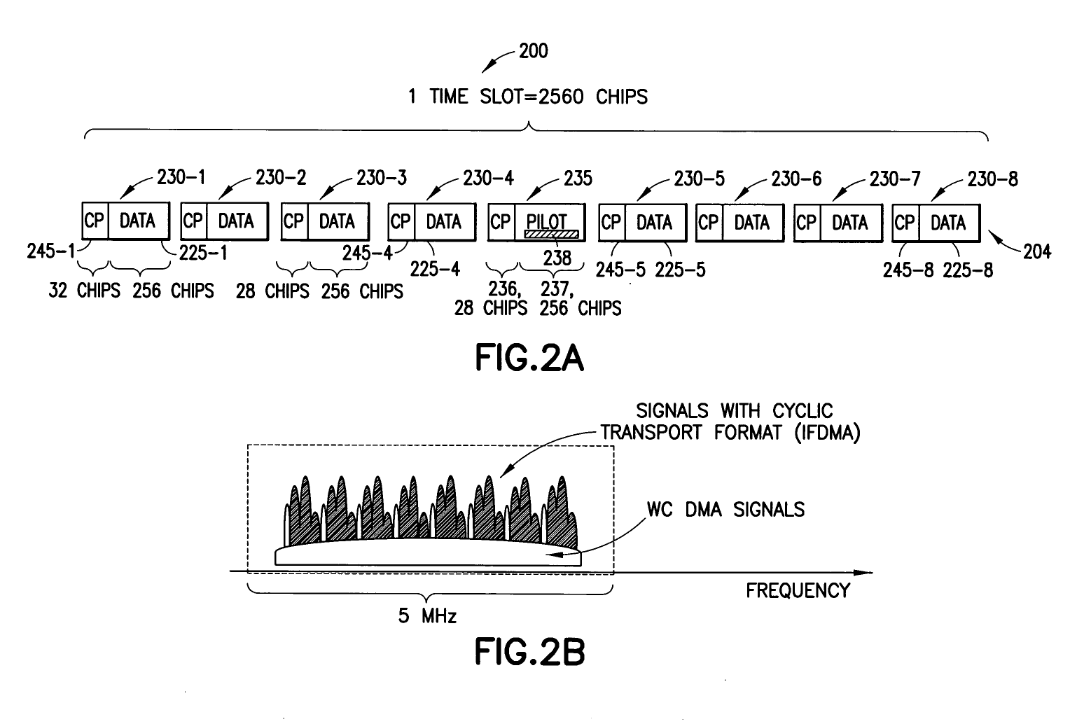

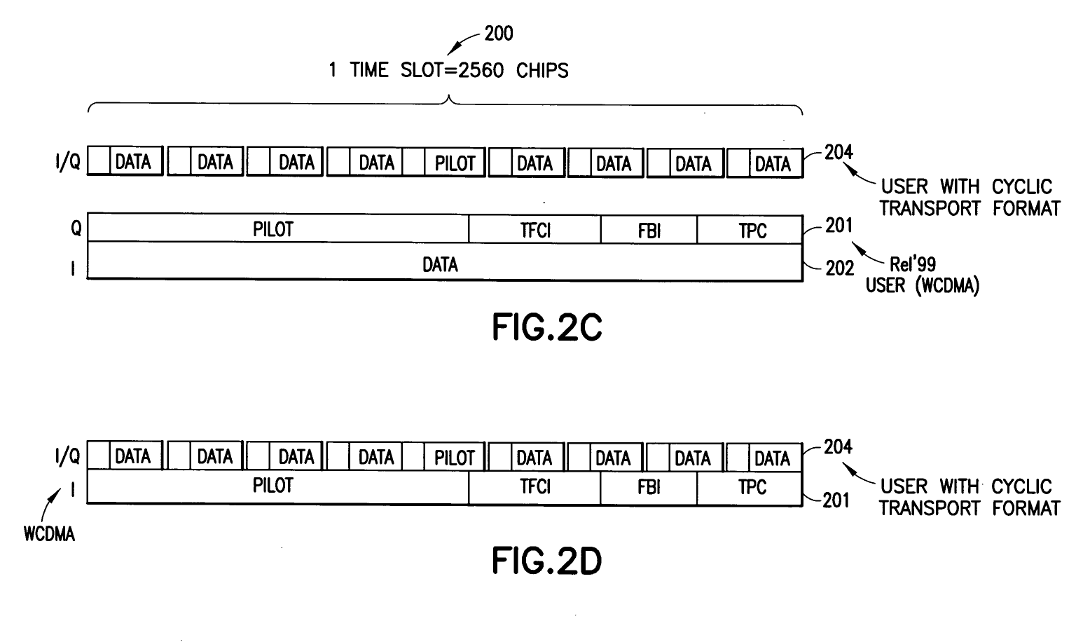

Referring to FIG. 2A, the specifics of a cyclic transport format in accordance with exemplary embodiments of this invention include, as non-limiting examples: eight data symbols (called data blocks 230, including data blocks 230-1 through 230-8) and one pilot symbol (called a pilot data block 235) per timeslot 200. The data blocks 230 and pilot data block 235 are the timeslot data 204. Each data block 230 includes a cyclic prefix 245 (including cyclic prefixes 245-1 through 245-8) and a data portion 225 (including data portions 225-1 through 225-8). The pilot data block 235 includes a cyclic prefix 236 and a pilot data portion 237. One timeslot 200=(9*256+8*28+1 *32) chips=2560 chips; a timeslot duration=0.66666 milliseconds (ms) (2/3 ms) and a chip rate=2560 chips/0.66666 ms=3.84 Mchips/s (million chips per second). The overall pilot allocation of the waveform is about 11 percent, and the CP duration is about 7.3 microseconds, or 28 chips (the first CP: 8.3 microseconds, 32 chips). The peak data rate is 10.24 Mb/s (assuming 16QAM, 5/6). Note that these specific values are compatible with WCDMA/HSUPA parameters, and are furthermore intended to be read as exemplary, and to not limit the use or practice of the exemplary embodiments of this invention. The pilot data portion 237 of the pilot data block 235 includes in this example a reference signal 238. Reference signals are typically CAZAC (Constant Amplitude Zero Autocorrelation) sequences. Orthogonal reference signals (e.g., for each UE) can be provided by means of IFDMA (e.g., every eighth pin) or by means of CDMA (e.g., utilizing different cyclic shifts of a CAZAC sequence).

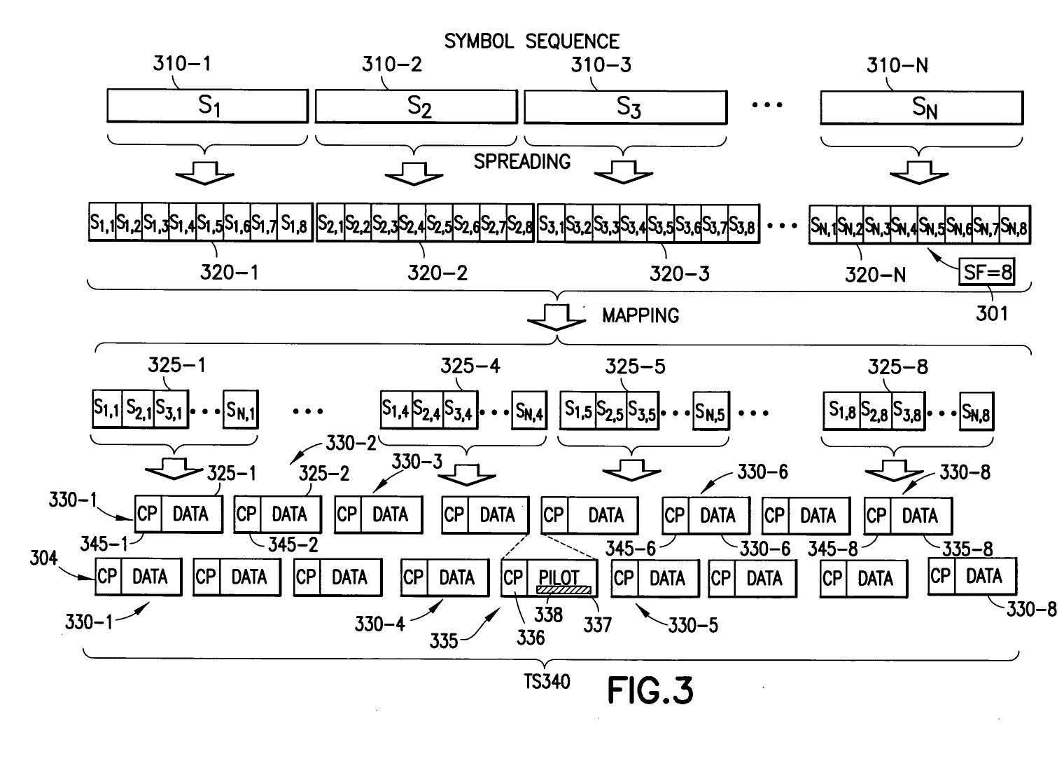

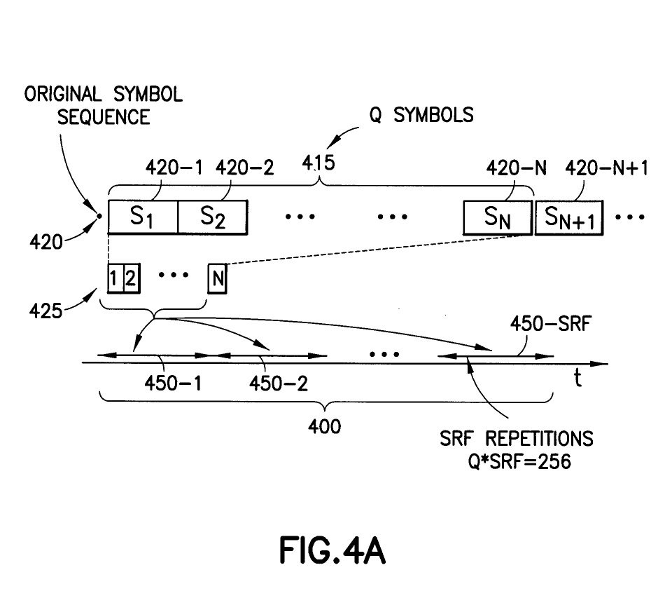

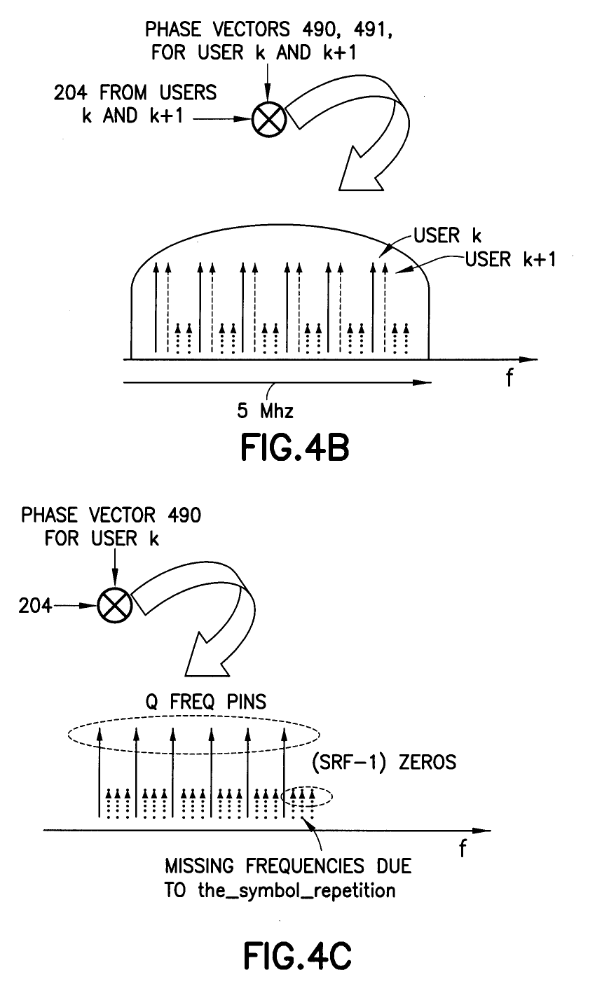

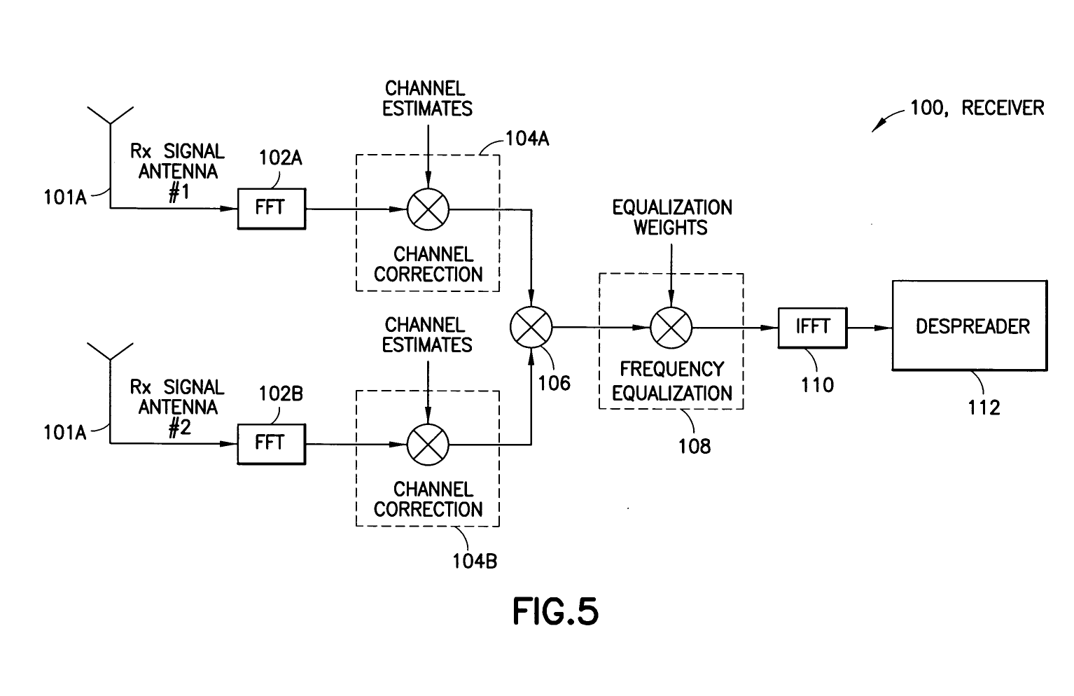

In accordance with the exemplary embodiments of the invention, and referring to FIG. 2B, WCDMA (HSUPA) users (using the timeslot data 201 and 202) and those users utilizing the cyclic transport format (using the timeslot data 204) can be multiplexed into the same frequency band. Both transport formats may be used simultaneously. FIG. 2B is an example of IFDMA (described with respect to FIGS. 4A-4C, 11, and 12), but the example of Frequency Division Pilot Access DS CDMA (described with respect to FIGS. 3, 9, and 10) would also allow both transport formats to be used simultaneously.

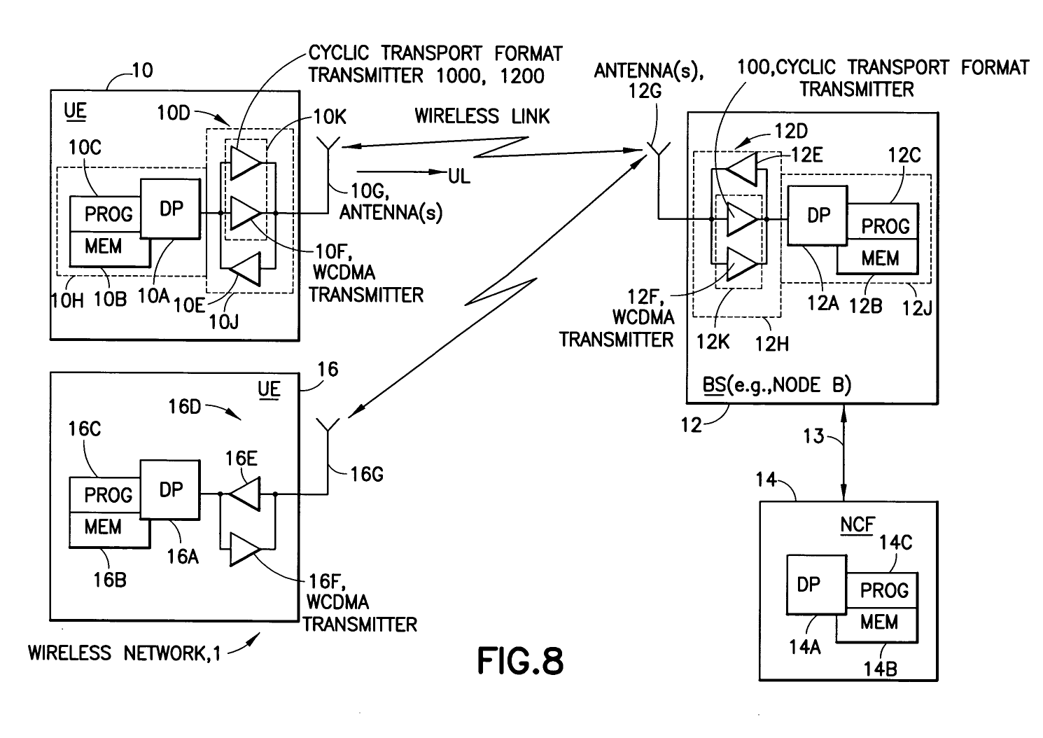

FIG. 2C shows an exemplary use case where some portion of users (e.g., using UE 10 as shown in FIG. 8) utilize the WCDMA UL transmission scheme with I/Q (In phase/Quadrature) multiplexed pilot and data (e.g., timeslot data 201), and another portion of users utilize the cyclic transport format (e.g., timeslot data 204) in accordance with the exemplary embodiments of this invention. The division may be done, for example, in such a way that users not supporting the cyclic transport format utilize the WCDMA transmission scheme, or users with low UL data rates utilize the conventional WCDMA transmission scheme.

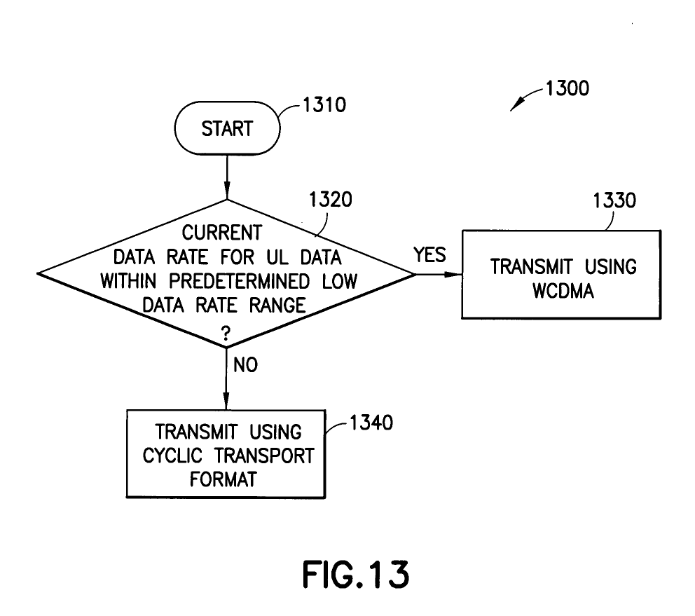

For instance, FIG. 13 shows a method 1300 performed by (e.g., a data processor) of a UE. The method begins in action 1310. In action 1320, it is determined whether the current data rate for UL data is within a predetermined low data range (e.g., is below some predetermined data rate). As examples, the low data range could be e.g., 64 kb/s or 128 kb/s or under. If so (action 1320=YES), the UE transmits using WCDMA (action 133). If not (action 1320=NO), the UE transmits using the cyclic transport format described herein (action 1340).

In one exemplary embodiment, those users utilizing the cyclic transport format transmit the physical layer control signaling (e.g., DPCCH) using the WCDMA transmission scheme, and transmit just the scheduled data using the cyclic transport format, as illustrated in FIG. 2D. One non-limiting benefit of this approach is that implications to the current WCDMA physical layer control signaling, such as PC commands and TFCI, are minimized.

With regard to spreading and mapping, there are two different exemplary options for spreading and mapping: a) FDPA DS CDMA (Frequency Division Pilot Access DS CDMA), (see FIG. 3); and b) IFDMA (see FIGS. 4A-4C). With the both approaches, the mutual orthogonality between the parallel channels is maintained also in a frequency selective channel. iFDMA is obtained using a symbol repetition principle, which can also be utilized for chips (chip repetition (VSCRF CDMA)).

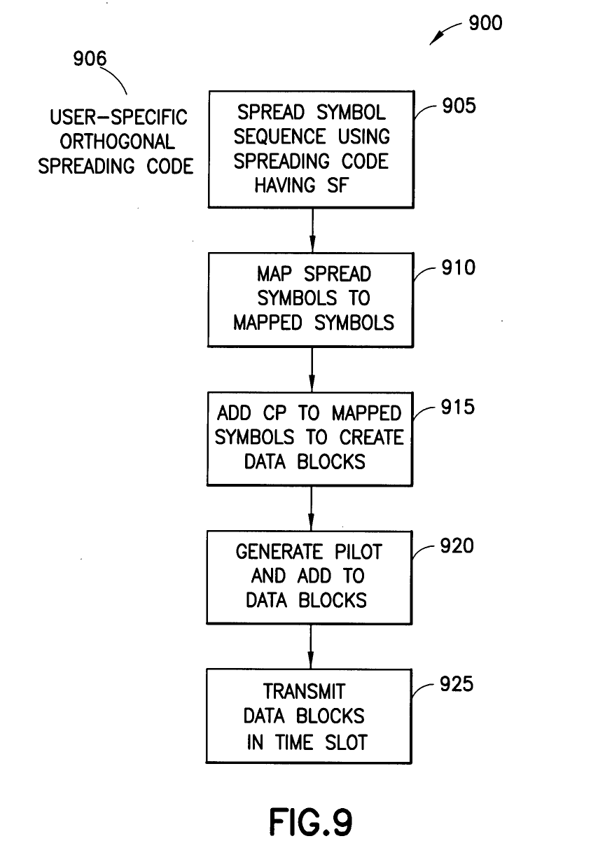

Turning now to FIGS. 3 and 9, in FIG. 3, an example is shown related to realizing orthogonal multiple access between UEs using the cyclic transport format herein for a FDPA DS CDMA (Frequency Division Pilot Access DS CDMA) embodiment (see FIG. 3). In FIG. 9, an exemplary method 900 is shown that performs the realization, and to transmit data in accordance with the realization, of FIG. 3. The method 900 would be performed, e.g., by a data processor in a user equipment, as shown in FIG. 8, discussed below. The symbol sequence 310, including symbols 310-1 through 310-N, are spread (action 905 ) by using a spreading code 906 having a spreading factor (SF) 301 of eight in this example. The spreading codes 906 are user-specific and can be Walsh-Hadamard codes, CAZAC codes or any other known sequences. The spread symbols 320 , including spread symbols 320-1 through 320-N, are mapped (action 910) to mapped symbols 325 , which include mapped symbols 325-1 through 325-8.

Cyclic prefixes 345, including cyclic prefixes 345-1 through 345-8, are added (action 915) to create data blocks 330, including data blocks 330-1 through 330-N. A cyclic prefix 325 includes data from the end of the mapped symbols 325. For instance, cyclic prefix 345-1 could include symbol portion S_{N,1} or S_{x,1}, Sₓ₊₁, . . ., S_{N,1}, where x is less than N. A pilot data block 335, including cyclic prefix 336 and pilot data portion 337, is generated and added (action 920) to the data blocks 330. The pilot data portion 337 includes one 338 of the orthogonal reference signals, which are generated in action 920. It is noted that the orthogonal reference signals may be previously generated and accessed in action 920. The pilot data block 335 and data blocks 330 are suitable for filling a timeslot 340, which is equivalent to the timeslot 200 as shown in FIG. 2A. In action 925, the timeslot data 304 (including data blocks 330, 335) are transmitted in the timeslot 340. This transmission is performed under control of, e.g., a data processor.

It is noted that orthogonality is created in FIG. 3 at least by using orthogonal spreading codes 906 with a given spreading factor 301. Different user equipment would be assigned different spreading codes 906 and data from the different user equipment would therefore be orthogonal.

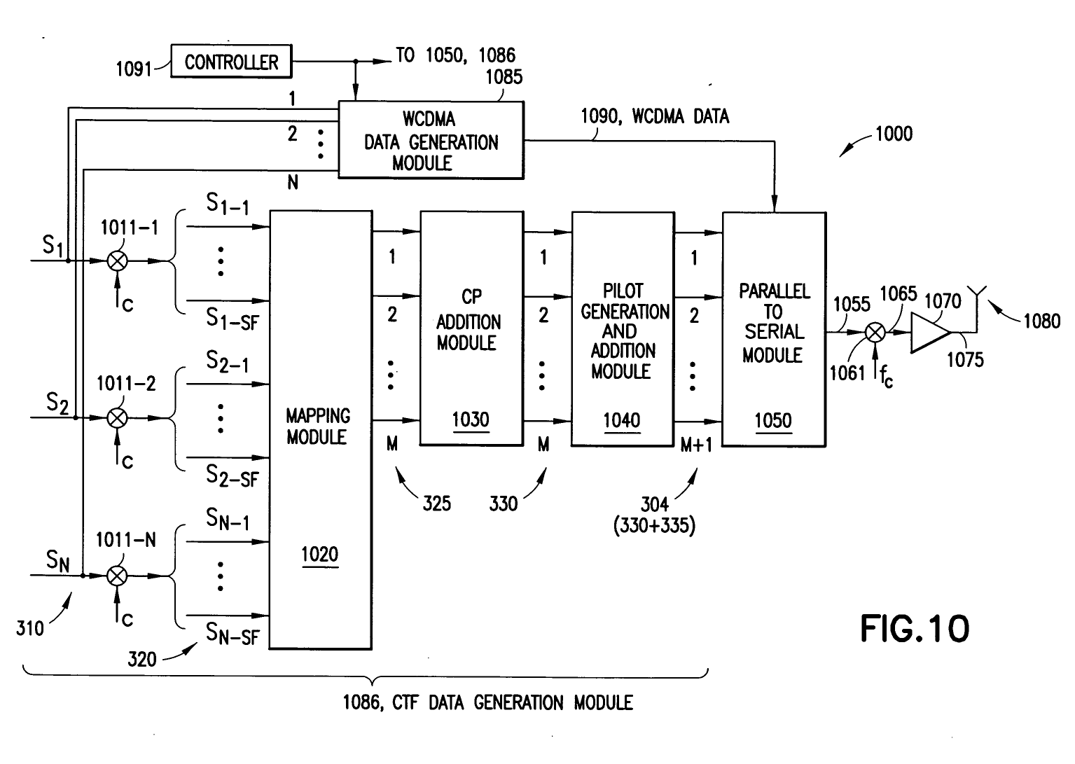

Referring to FIG. 10, this figure shows an exemplary transmitter 1000 suitable for generating cyclic transport format with CDM type of multiple accesses as described in reference to FIG. 3 and also suitable for generating WCDMA data and for transmitting the generated data. The transmitter could be formed as part of, e.g., a user equipment, as shown in FIG. 8, discussed below. In this example of a transmitter 1000, data for transmission is generated using either the WCDMA data generation module 1085 or the CDM type of cyclic transport format (CTF) data generation module 1086. The WCDMA data generation module 1085 produces WCDMA data 1090 (e.g., timeslot data 201 or 202) and the cyclic transport format (CTF) data generation module 1086 produces timeslot data 304. The cyclic transport format data generation module 1086 includes multipliers 1011, a mapping module 1020, a cyclic prefix addition module 1030, and a pilot generation and addition module 1040.

The symbol sequence 310 is spread using spreading code c (i.e., a user-specific orthogonal spreading code 906 ) and multipliers 1011, including multipliers 1011-1 through 1011-N. A mapping module 1020 maps the spread symbols 320 to create the mapped symbols 325. In the example of FIG. 3, M was eight, but could be one, two, four, or eight (i.e., factors of the M; M is limited to eight only in this example) and has a limit of the spreading factor 301. The CP addition module 1030 adds a cyclic prefix 345 to create data blocks 330. The pilot generation and addition module 1040 then generates and adds the pilot data block 335 to create a filled timeslot 340, including data blocks 335 and pilot data block 335 that are timeslot data 304. It is noted that the pilot generation and addition module 1040 could also access a previously generated pilot data block 335. A parallel to serial module 1050 converts the parallel data blocks 304 (including 330, 335) or the WCDMA data 1090 to a serial signal 1055 to which a carrier frequency (f_{c}) is added using multiplier (e.g., mixer) 1061 to create a radio frequency signal 1065. An amplifier 1070 amplifies the radio frequency signal 1065 to create amplified radio frequency signal 1075, which is transmitted using antenna 1080.

The parallel to serial module 1050 (e.g., under control of a controller 1091 such as a data processor) selects which data of the WCDMA data 1090 or the timeslot data 304 to transmit. Additionally, a controller 1091 such as a data processor can cause either the WCDMA data generation module 1085 or the cyclic transport format data generation module 1086 to be used.

It is noted that the elements shown in FIG. 10 are merely for expository purposes. For instance, the mapping module 1020 and cyclic prefix addition module 1030 and pilot generation and addition module 1050 could be combined. The functions performed by, e.g., the mapping module 1020 and cyclic prefix addition module 1030 and pilot generation and addition module 1040 could be performed by software, hardware, or some combination thereof. As an example, the mapping module 1020 might be implemented as a circuit on an integrated circuit, while the cyclic prefix addition module 1030 and pilot generation and addition module 1040 could be implemented as software instructions performed by a data processor on the integrated circuit. A typical implementation would have the controller 1091, the WCDMA data generation module 1085, and the cyclic transport format data generation module 1086, implemented by software executed by a data processor, while and the parallel to serial module 1050, multiplier 1061, and amplifier 1070 are performed in hardware.

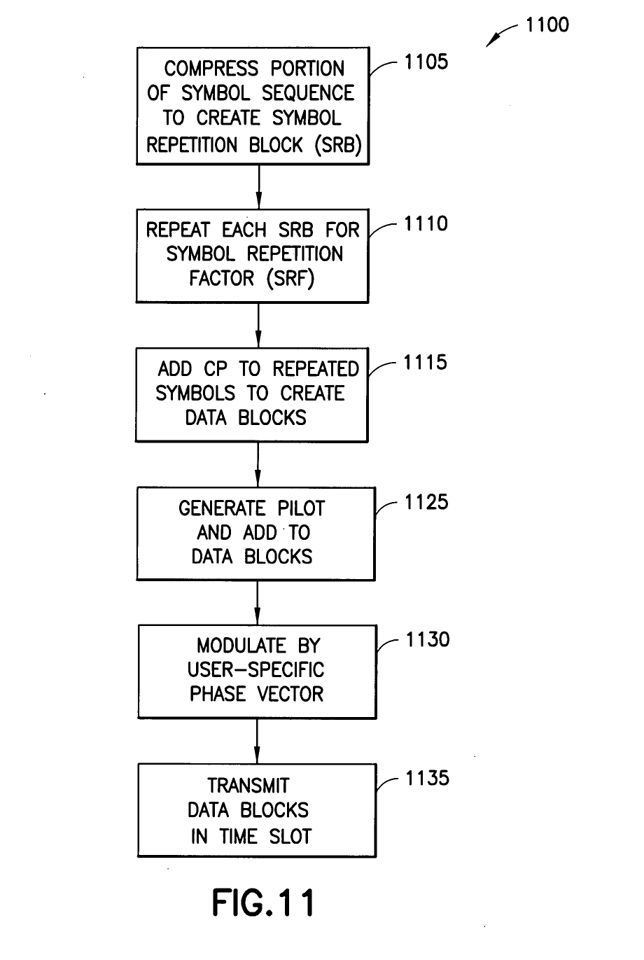

Turning now to FIGS. 2A, 4A-4C and 11, FIG. 4A shows an example related to realization of orthogonal multiple access between UEs using the cyclic transport format for an IFDMA embodiment. FIG. 4B shows an exemplary result of using the symbol repetition and compression of FIG. 4A after modulation (e.g., scrambling) using user-specific phase vectors for two users. FIG. 4C shows an exemplary result of using the symbol repetition and compression of FIG. 4A after modulation using user-specific phase vectors for a single user. FIG. 11 shows a flowchart of an exemplary method 1100 to perform the realization, and to transmit spread and mapped data, of FIGS. 4A-4C. The method 1100 would be performed, e.g., by a data processor in a user equipment, as shown in FIG. 8, discussed below.

In FIG. 4A, a symbol sequence 420 is shown, of which symbols 420-1 through 420-N+1 are shown in this example. A portion 415, which includes N symbols 420-1 through 420-N, is compressed (action 1105) into a symbol repetition block 425. This compression is typically based on data rate. The symbol repetition factor (SRF) acts as a spreading factor. The higher is the repetition/spreading factor, the smaller is the symbol rate (thereby data rate). The symbol repetition block 425 has a size of Q (also N in this example). The symbol repetition block 425 is repeated (action 1110) for symbol repetition factor (SRF) repetitions to create repeated symbols 450, including repeated symbols 450-1 through 450-SRF. In this example, Q*SRF=256, such that the data portion 400 occupies 256 chips and therefore is used as a data portion 230 in the timeslot 200 of FIG. 2A.

In action 1115, a cyclic prefix is added to the repeated symbols 450 to create a data block 230 (see FIG. 2A). As shown in FIG. 2A, there are eight data blocks 230, so actions 1105, 1110, and 1115 create eight data blocks 230. In action 1125, a pilot data block 235 is generated and added to the data blocks 230. As described above, a pilot data block 235 could be previously generated and action 1125 could simply access the previously generated data block.

In action 1130, modulation is performed by applying user-specific (e.g., complex) phase vectors to the data blocks 230, 235. The symbol repetition (e.g., by SRF repetitions) creates the comb-shaped frequency spectrum (e.g., Q pins, SRF-1 zeros). Modulation by the phase vector performs a correct frequency shift for the given frequency spectrum. For multiple users, each of user k and user k+1 would be assigned different user-specific phase vectors 490, 491, respectively. Modulation performed by multiplying the phase vectors 490, 491 for users k and k+1 with the data blocks 230, 235 (e.g., the information in timeslot data 204) from these users has the effect of creating frequency division multiplexing as shown in FIG. 4B. In the example of FIGS. 4B and 4C, Q=6 and SRF=4. Note that the 5 MHz frequency band shown in FIG. 4B is the frequency band typically used by WCDMA in the UL.

In action 1135, the data blocks 230, 235 are transmitted in timeslot 1135. This transmission takes place under control, e.g., of a data processor.

It is noted that the spreading and mapping (CDM) (see, e.g., FIGS. 3 and 9) and block repetition and UE-specific phase modulation (FDM) (see, e.g., FIGS. 4A-4C and 11) are alternative ways to realize orthogonal multiple access between UEs using the cyclic transport format (e.g., of FIG. 2A).

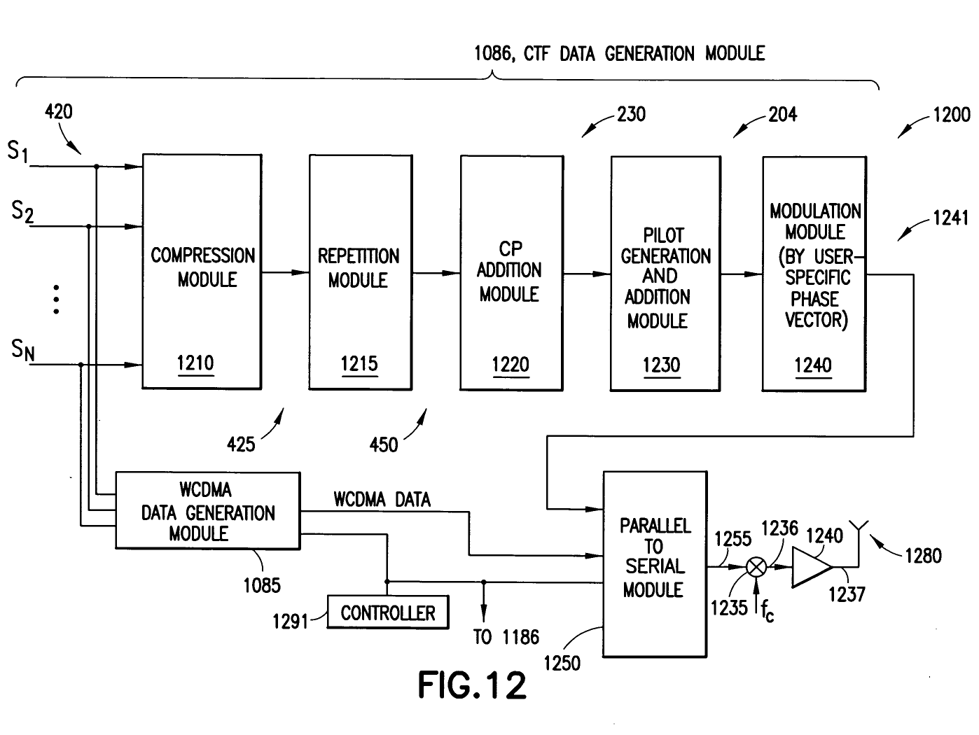

FIG. 12 shows an exemplary transmitter 1200 suitable for generating cyclic transport format data as described in reference to FIGS. 4A-4C and also suitable for generating WCDMA data and for transmitting the generated data. The transmitter 1200 could be part of, e.g., a user equipment, as shown in FIG. 8, discussed below. The transmitter 1200 generates data suitable for transmission by using either the cyclic transport format (CTh) data generation module 1186 or the WCDMA data generation module 1085. The WCDMA generation module 1085 produces WCDMA data 1090 (e.g., timeslot data 201 or 202) and the cyclic transport format data generation module 1186 produces modulated data blocks 1241, and the parallel to serial module 1250 selects between the two data 1090 or 1241. A controller 1291, such as a data processor, controls the parallel to serial module 1250 to select the data 1090 or 1241 and also controls which of the WCDMA data generation module 1085 or cyclic transport format data generation module 1186 is used to generate the data 1090 or 1241, respectively. The cyclic transport format data generation module 1186 includes the compression module 1210, the repetition module 1215, the cyclic prefix addition module 1220, the pilot generation and addition module 1230, and the modulation module 1240.

Transmitter 1200 includes a compression module 1210 that operates to compress (e.g., a portion of) the symbol sequence 420 into Q compressed symbols 425. The repetition module 1215 repeats the compressed symbols SRF times. The cyclic prefix (CP) addition module 1220 operates to add a cyclic prefix 426 to the compressed symbols 430 to create data blocks 230. The pilot generation and addition module 1230 generates pilot data (e.g., or accesses previously generated pilot data) to create a pilot data block 235 and add the pilot data block 235 to the data blocks 230. The modulation module 1240 applies (e.g., multiplies) a user-specific phase vector 490 (see FIG. 4C) to the repeated data blocks 450 to create modulated data blocks 1241. The modulated data blocks 1241 or the WCDMA data 1090 are converted to a serial signal 1255 by the parallel to serial module 1230. The carrier frequency (f_{c}) is added using multiplier (e.g., mixer) 1235 to create a radio frequency signal 1236. An amplifier 1240 amplifies the radio frequency signal 1236 to create amplified radio frequency signal 1237, which is transmitted using antenna 1250.

It is noted that the elements shown in FIG. 12 are merely for expository purposes. For instance, these elements could be combined or further subdivided. The functions performed by these elements could be performed by software, hardware, or some combination thereof.

FIG. 5 shows a simplified block diagram of a receiver 100 suitable use with the cyclic transport format. Note that a time domain realization of the receiver 100 is also possible. It is noted that the elements of FIG. 5 may also be considered actions of a method. In FIG. 5 received signals from two antennas 101A, 101B are each applied to a FFT (Fast Fourier Transform) block 102A, 102B and then to channel correction blocks 104A, 104B that receive corresponding channel estimates. The outputs of the channel correction blocks 104A, 104B are summed at 106 and applied to an equalizer 108 that receives equalization weights. The channel corrected, combined and equalized received signal is then applied to IFFT (Inverse Fast Fourier Transform) block 110, the output of which is applied to a despreader module 112. The despreader module 112 functions to, e.g., despread the received data. Two different techniques for spreading data were shown above, and corresponding techniques for despreading data will now be described.

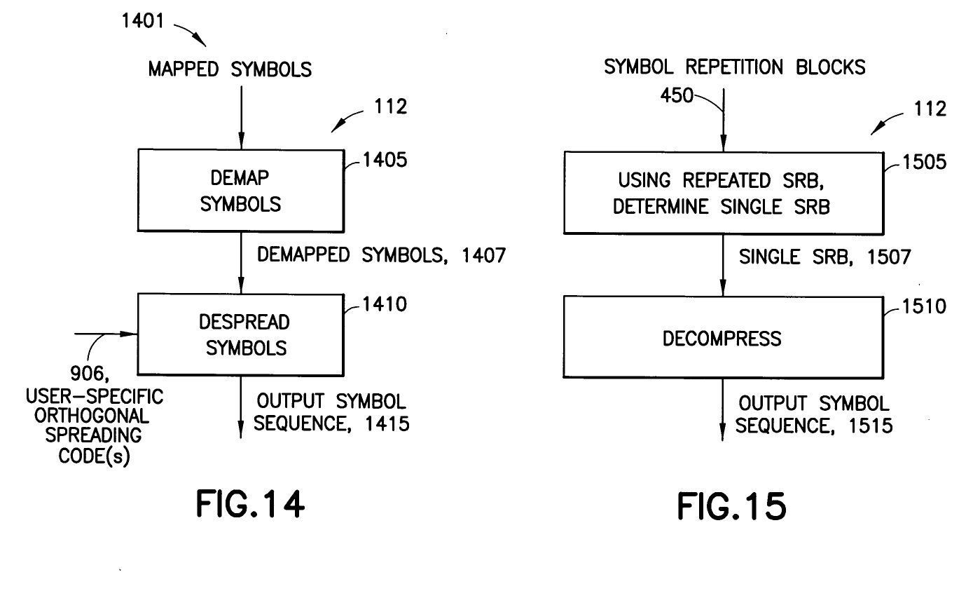

FIG. 14 is a flowchart for despreading data transmitted using the techniques of FIGS. 3 and 9. The blocks in flowchart in FIG. 14 can be considered to be actions performed by a method or elements of the despreader module 112. It is noted that the pilot symbol is removed prior to 112 and goes into forming the channel estimates (see FIG. 5). In block 1405, mapped symbols 1401 (e.g., mapped symbols 325) are demapped. In block 1410, the demapped symbols 1407 are despread, e.g., using one or more user-specific orthogonal spreading codes 906 (see also FIG. 9), to create an output symbol sequence 1415, which should (given no errors) be equivalent to the symbol sequence 310. Typically, signals from multiple users would be received, and therefore multiple user-specific orthogonal spreading codes 906 would be used.

FIG. 15 is a flowchart for despreading data transmitted using the techniques of FIGS. 4A-4C and 11. The blocks in flowchart in FIG. 15 can be considered to be actions performed by a method or elements of the despreader module 112. In this example, symbol repetition blocks 450 (typically, without the cyclic prefix) are used in block 1505 to determined a single symbol repetition block 1507. In block 1510, the single symbol repetition block 1507 is decompressed to create output symbol sequence 1515, which should (given no errors) be equivalent to the symbol sequence 420.

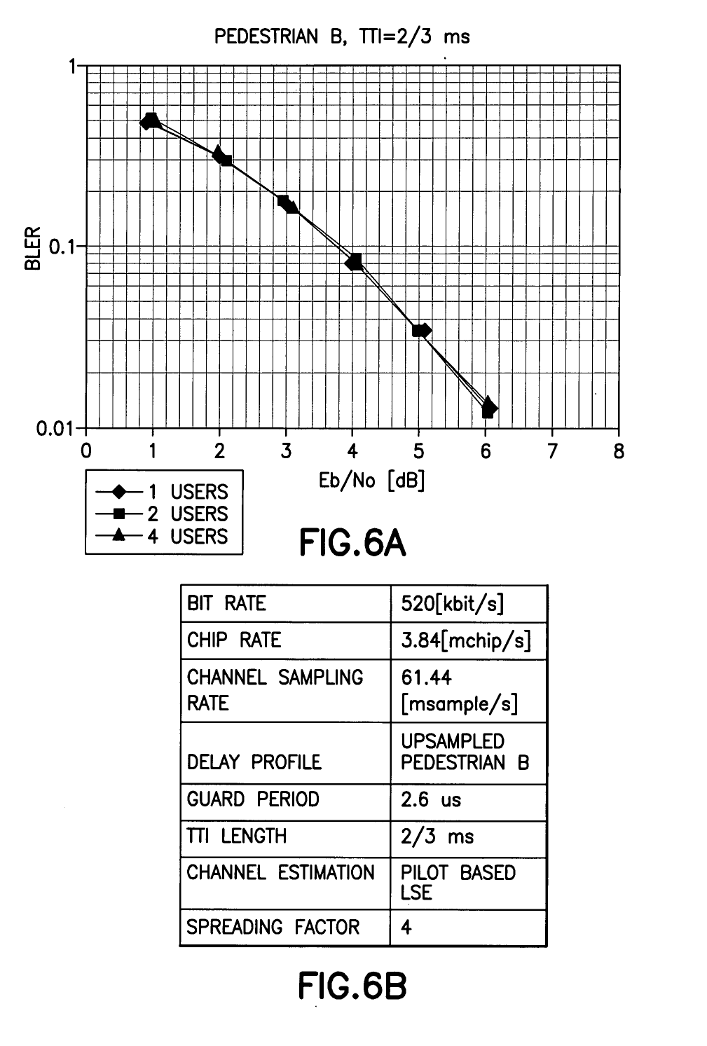

FIG. 6A shows a performance example assuming the conditions listed in the Table of FIG. 6B. Further in this regard it can be noted that FDPA DS CDMA can provide perfect orthogonality between users utilizing the same resource (e.g., frequency selective channel), and that this case is also met with IFDMA.

With respect to various use cases, note that some of the users-may utilize the current transport format (i.e., WCDMA), typically low data rate users. The cyclic transport format in accordance with the exemplary embodiments of this invention may replace the transmission scheme of HSUPA, where the DPCCH may be the same as in Release 4 of HSUPA, thereby requiring minimal changes at the physical layer (PHY). Note again that the DPCCH and the cyclic transport formatted signals, in accordance with the exemplary embodiments of this invention, may be transmitted simultaneously, as interference from the DPCCH is not significant.

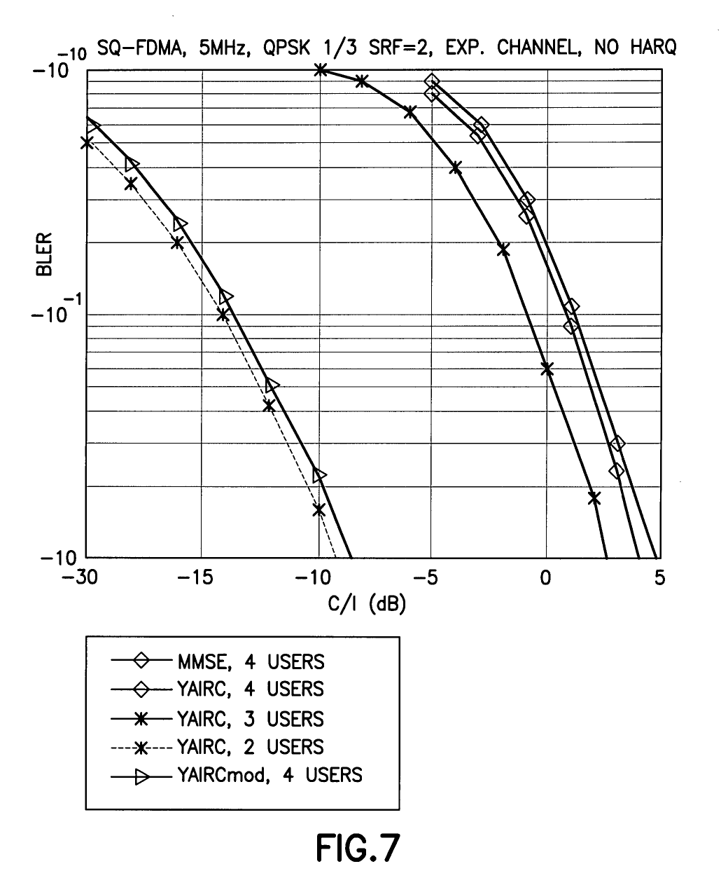

The cyclic transport format in accordance with the exemplary embodiments of this invention may be applied for scheduled users, where IRC may be used to mitigate the interference caused by the dominant interferers. A scheduler is preferably operated in such a way that the interference scenario for IRC becomes favorable. Reference in this regard can be made to FIG. 7 (an IFDMA case with a symbol repetition factor of two and two receive antennas). In FIG. 7, YAIRC is a modified version of IRC capable of handling wideband single-carrier signals.

Using a modified version of IRC, it is possible to increase the IRC potential by cancelling part of the interference by FDMA, and the remainder of the interference by IRC (this type of operation is generally not possible with WCDMA).

Other factors to consider relate to time and frequency synchronization. With regards to time synchronization, in order to maintain orthogonality between different FDPA DS CDMA users all signals should arrive to the BS receivers (e.g., receiver 100 of FIG. 5) within a guard period (e.g., 7.3 microseconds) comprised of a delay dispersion of the radio channel plus a delay dispersion between different users. A timing adjustment may be utilized at least in large cells to facilitate this arrival. With regards to frequency synchronization, it can be noted that the selected symbol length (256) corresponds to a pin separation of 15 kHz. The coarse requirement for frequency synchronization is about plus or minus 1.5 kHz (about 10 percent from pin separation). The selected pin separation provides sufficient resistance against multiple access interference (MAI) caused by Doppler effects.

Implementation of the cyclic transport format in accordance with the exemplary embodiments of this invention may be achieved through the use of a software update for current UE transmitters and BS receivers.

Reference is made to FIG. 8 for illustrating a simplified block diagram of various electronic devices that are suitable for use in practicing the exemplary embodiments of this invention. In FIG. 8, a wireless network 1 is adapted for communication with a UE 10 via a Base Station (BS) 12 and via a wireless link. Exemplary embodiments of the disclosed invention concern the uplink (UL) portion of the wireless link. The network 1 may include at least one network control function (NCF) 14. The UE 10 includes at least one data processor (DP) 10A, a memory (MEM) 10B that stores a program (PROG) 10C, and a suitable radio frequency (RF) transceiver 10D for bidirectional wireless communications with the BS 12 (e.g., a Node B or enhanced Node B) using antenna(s) 10G. The RF transceiver 10D includes a cyclic transport format transmitter 1000, 1200 (described above), a receiver 10E, and a WCDMA transmitter 10F. The transmitters 1000/1200 and 10F are shown separately, but will typically be the same transmitter 10K. In this example, the memory 10B and data processor 10A are formed as part of an integrated circuit 10H, and the RF transceiver is formed as part of one or more additional integrated circuits 10J.

The wireless network 1 also includes a “legacy” UE 16 that includes a MEM 16B, a Prog 16C, a DP 16A, an RF transceiver 16D and an antenna 16G. The transceiver 16D includes a receive 16E and a WCDMA transmitter 16F. The UE 16 is considered a legacy UE because the UE 16 supports only WCDMA transmission and does not support the cyclic transport format transmissions described herein.

The BS 12 includes a DP 12A, a MEM 12B that stores a PROG 12C, and a suitable RF transceiver 12D. The BS 12 includes or is coupled to antenna(s) 12G. The transceiver 12D includes in this example a transmitter 12E, a cyclic transport format receiver 100, and a WCDMA receiver 12F. Although the cyclic transport format receiver 100 and WCDMA receiver 12F are shown separately, these would typically be the same receiver 12K. In this example, the DP 12A and MEM 12B are formed as part of an integrated circuit 12H, and the transceiver 12D is formed as one or more additional integrated circuits 12J.

The BS 12 is coupled via a data path 13 to the NCF 14 that also includes a DP 14A and a MEM 14B storing an associated PROG 14C. At least the PROGs 10C and 12C are assumed to include program instructions that, when executed by the associated DP, enable the electronic device to operate in accordance with the exemplary embodiments of the invention so as to transmit and receive the UL cyclic transport formatted waveform, as described above. The embodiments of this invention may be implemented by computer software executable by the DP 10A of the UE 10 and the DP 12A of the BS 12, or by hardware, or by a combination of software and hardware.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B, and 14B may be of any type suitable to the local technical environment and may be implemented using any suitable data storage technology, such as semiconductor based memory devices, magnetic memory devices and systems, optical memory devices and systems, fixed memory and removable memory. The DPs 10A, 12A, and 14A may be of any type suitable to the local technical environment, and may include one or more of general purpose computers, special purpose computers or circuits, microprocessors, digital signal processors (DSPs) and processors based on a multi-core processor architecture, as non limiting examples. A computer program product, e.g., as part of MEM 10B, 12B, and 14B, may also be included. The computer program product tangibly embodies a program of machine-readable instructions executable by one or more data processors to perform operations described herein. Such a computer program product could be part of a MEM, a digital versatile disk (DVD), compact disk (e.g., CDROM), memory stick, or any other short- or long-term memory.

In terms of signaling from the base station 12 to the UE 10 to support exemplary embodiments herein, signaling information from the base station 12 to the UE 10 may include the following information elements:

1) For IFDMA, the signaling information can include the chip/symbol repetition factor and the phase vector or index for the phase vector; and

2) For FDPA-DS-CDMA, the signaling information can include the spreading factor and the spreading code or index for the spreading code.

Additionally, information related to the used modulation and coding and HARQ scheme is also typically needed at the UE 10.

A number of advantages can be realized through the use of the exemplary embodiments of this invention as described above. For example, in a UTRAN LTE context capacity gains of the order of 100% to 200% can be achieved, as compared to HSUPA. Since the radio performance of the cyclic transport format is close to that of the UTRAN LTE UL, it is reasonable to assume that a majority of the UL gain provided by the cyclic transport format should be obtainable as well in the HSUPA system that is of particular interest to this invention.

In addition, UL MIMO techniques are facilitated since the pilots of the multiple data streams can be orthogonalized by means of IFDMA. As a result, the potential to deploy MIMO is higher than with only a WCDMA approach. In addition, on top of MIMO higher order modulations can be employed as well.

The use of the cyclic transport format in accordance with the exemplary embodiments of this invention also provides a smooth upgrade path for current 3G users.

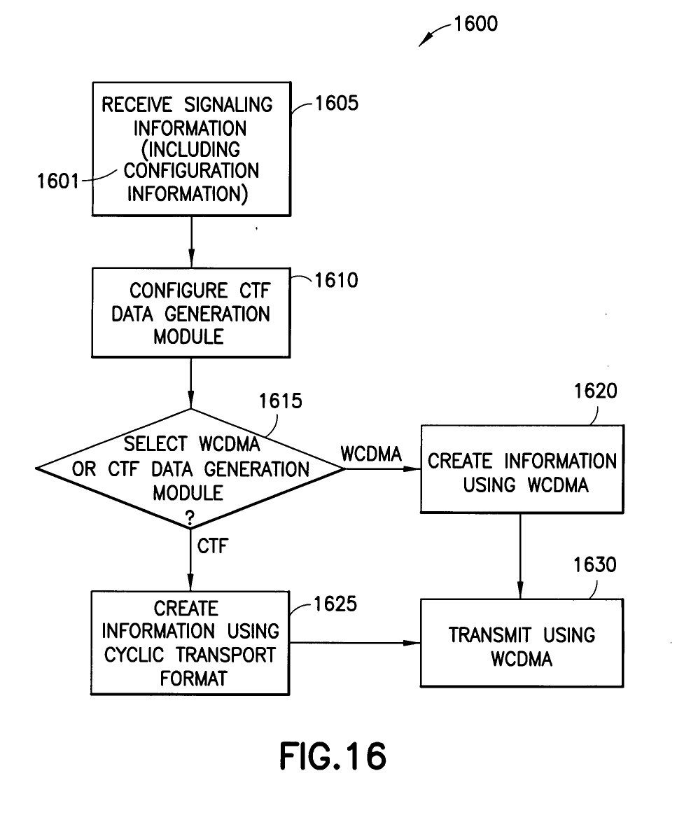

In FIG. 16, a flowchart of a method 1600 is shown for creating and transmitting data using either a WCDMA transport format or cyclic transport format. Method 1600 would be performed by, e.g., UE 10 (e.g., DP 10A). In action 1605, the UE 10 receives signalling from the BS 12. The signalling information can include numbers 1) and 2) above. Additionally, configuration information 1601 can be included, such as whether the UE 10 is to be configured to perform one of FIGS. 2C, 2D, or 13. In action 1610, the UE 10 configures the cyclic transport format data generation module to create, e.g., cyclic transport format data generation module 1086 or 1186.

In action 1615, the UE 10 selects either the WCDMA data generation module 1085 or the cyclic transport format data generation module (e.g., 1086/1186 ). If WCDMA is selected, in action 1620, the WCDMA data generation module 1085 generates WCDMA information from an input symbol sequence. If cyclic transport format is selected, in action 1625, the cyclic transport format data generation module (e.g., 1086/1186 ) generates cyclic transport format information from an input symbol sequence. In block 1630, the information is transmitted in the timeslot. It is noted that a combination of creating information and transmitting information causes the transmitted information to be transmitted in a particular frequency band. For instance, for creation of cyclic transport format information based on cyclic CDM, the operations shown in FIG. 3 cause the cyclic transport format information (e.g., timeslot data 304) to have a certain frequency band, but the multiplication by the carrier frequency, f_{c}, further modifies the location of the frequency band to occupy another frequency band.

Having thus described the exemplary embodiments of the invention disclosed in the copending U.S. Patent Application No. ______ with reference to FIGS. 1-16 above, a description is now made of the exemplary embodiments of the present invention, which include providing joint scheduling and a receiver for the abovementioned system consisting of terminals utilizing two different transmission schemes.

An aspect of the joint scheduling and receiver, in accordance with exemplary embodiments of the present invention, is to control the interference from high bit rate users in a way that a relatively simple advanced receiver (e.g., IRC, PIC) can achieve a large performance gain. As a non-limiting example, the high bit rate users are allocated and scheduled into orthogonal resources in the time and/or frequency domain (e.g., using the cyclic transport format and IFDMA), while low bit rate users (e.g., 64-384 kbit/s users) are spread over and allocated to the entire transmission bandwidth (e.g., using the WCDMA transport format). The term scheduling refers to the arrangements of radio resources. In this example, joint scheduling means that the arrangement of radio resources is made jointly between cyclic transport format and WCDMA. The (orthogonal) high bit rate users may then be detected by using a relatively simple linear receiver 100. In general, the receiver 100 has an interference suppression capability to suppress the interference caused by the high bit rate user(s). This approach can thus beneficially provide a significant increase in cell throughput with reasonable receiver (and transmitter) complexity.

The scheduling and receiver structure, in accordance with exemplary embodiments of the present invention, may be implemented in a system having both orthogonal time/frequency resources and non-orthogonal resources. Orthogonal resources are scheduled to the high bit rate users while un-scheduled users utilize non-orthogonal resources. One non-limiting example of this kind system is the possible 3G uplink evolution where IFDMA is applied to high bit rate users and CDMA for low bit rate users, as described above, e.g., in reference to FIG. 13. The system is scheduled in such a way that the received Ec/No of IFDMA users is in a range of about 0-10 dB, enabling modulations to be used from BPSK to 16 QAM. The Ec/No of CDMA users may be limited to, by example, less than 10 dB, enabling maximum data rates of about 300 kbits/s.

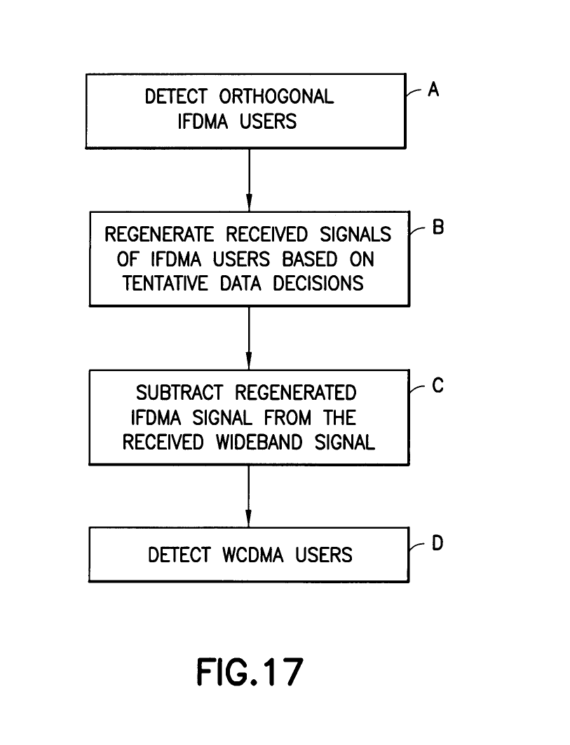

The receiver 100 has an interference suppression capability to suppress the interference originating from scheduled high bit rate user(s). Interference cancellation may be accomplished by the following steps, depicted also in FIG. 17.

A. Detection of orthogonal IFDMA users;

B. Regeneration of the received signals of IFDMA users based on tentative data decisions;

C. Subtraction of the regenerated IFDMA signal from the received wideband signal; and

D. Detection of the CDMA users

The detection described above with respect to Actions A and B of FIG. 17 include decoding, demodulation, and the like.

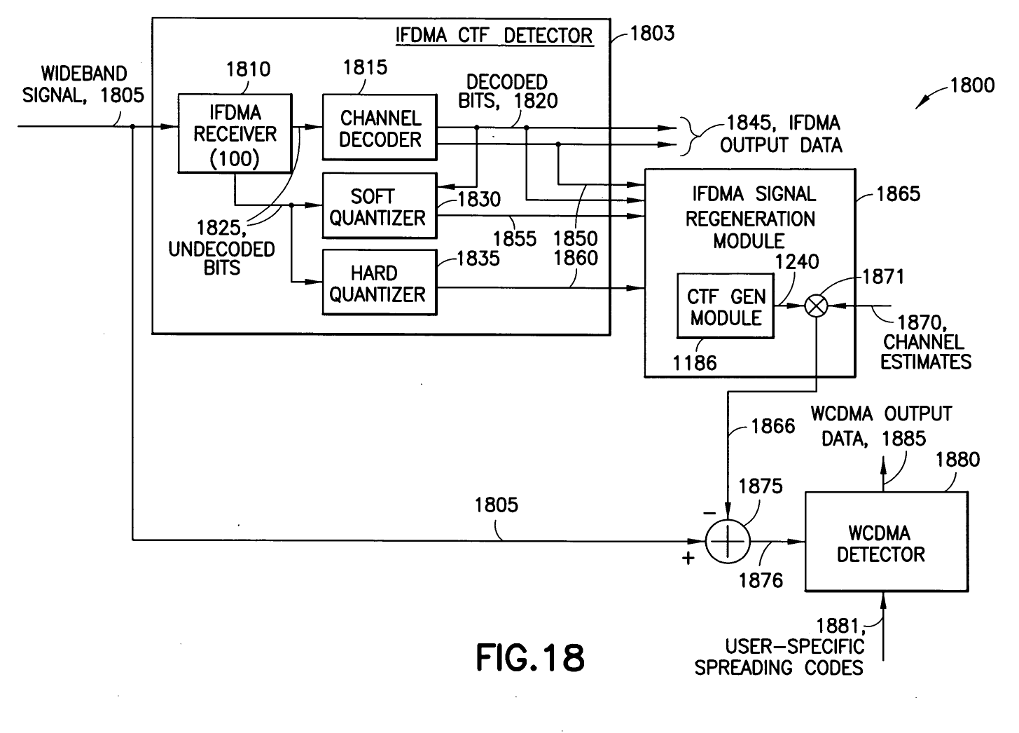

Turning to FIG. 18, a simple block diagram of a receiver 1800 is shown for performing joint detection of a WCDMA transport format and a cyclic transport format using IFDMA. In receiver 1800, a wideband signal 1805 is routed to the IFDMA CTF detector 1803 and to the adder 1875. The wideband signal 1805 is received from one or more antennas (e.g., antennas 101A and 101B of FIG. 5) and contains information from both a WCDMA transport format (see 201 and 202 of FIGS. 2C and 2D) and a cyclic transport format using IFDMA (see FIGS. 4A-4C and 11). The wideband signal 1805 is coupled to receiver 1810 (e.g., receiver 100 of FIG. 5). Undecoded bits 1825 from the receiver portions 1810 are coupled to the channel decoder 1815, the soft quantizer 1830, and the hard quantizer 1835. The undecoded bits 1825 are from, e.g., the output symbol sequence 1515 of FIG. 15. The channel decoder produces decoded bits 1820, which are the IFDMA output data 1845. It is noted that the IFDMA output data 1845 could include an indication 1850 of an error with a packet. The channel decoder 1815 can produce the indication 1850 of an error with a packet. The indication 1850 can be interpreted to indicate that a packet was received correctly (e.g., having no errors). A packet (not shown) typically includes several data blocks 230 (see FIG. 2A).

The soft quantizer 1830 can use either one of the undecoded bits 1825 or the decoded bits 1820 to determine soft quantized bits 1855. Typically, the soft quantizer would be configured to select only one of the undecoded bits 1825 or the decoded bits 1820. Soft quantizers are well known. The hard quantizer 1835 uses the undecoded bits 1825 and determines hard quantized bits 1860. Hard quantizers are well known. The IFDMA signal regeneration module 1865 uses one of the sets of bits 1820 (e.g., if indication 1850 indicates no errors), 1855, and 1860 and regenerates the IFDMA signals using, e.g., the cyclic transport format generation module 1186 (see FIG. 12). As described above, in FIG. 12, the cyclic transport format generation module 1186 takes a portion of input symbol sequence (in this case, from 1820, 1855, or 1860), compresses the symbols, repeats the compressed symbols, adds a cyclic prefix to each data block, adds a pilot data block, and modulates the entire timeslot data using user-specific phase vectors. It is noted that a receiver 1800 may receive data from multiple users, and therefore the cyclic transport format generation module 1186 may include multiple modules for all of the users or a single module operated for each of the users.

The IFDMA signal regeneration module 1865 uses the channel estimates 1870 (e.g., see FIG. 5) to modulate (using a modulator 1871 ) the signal(s) 1241 to create the regenerated signal 1866. The regenerated signal 1866 can include signals from all IFDMA users (e.g., added into a single signal) or could be multiple signals, one for each of the IFDMA users. The regenerated signal 1866 is subtracted from the wideband signal 1805 by the adder 1875. The adder 1875 can be any device configured to create a resultant signal 1876 based on the regenerated signals for all of the IFDMA users and on the received wideband signal 1805. The resultant signal 1876 is coupled to a WCDMA detector 1880, which produces a WCDMA output 1885 user-specific spreading codes 1881 (i.e., where a spreading code 1881 is assigned to each user, e.g., UE).

It should be noted that WCDMA is only one example. Exemplary embodiments of the disclosed invention may be used with any number of transport formats that use codes to multiplex users. It is also noted that the various items in FIG. 18 can be performed using software, hardware, or any combination thereof.

Various advantages that can be realized by the use of the exemplary embodiments of the present invention include, but need not be limited to, a significant increase in cell throughput with reasonable receiver (and transmitter) complexity, the complexity of the PIC receiver can be reduced significantly as only the interference from the dominant interferers is cancelled out (since there are only few major contributors for the increase of noise rise), and the efficiency of the PIC receiver can be improved. Note as well that the signaling overhead of control information can significantly reduced since the scheduling is utilized only for the high bit rate users.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
detecting first information in a received wideband signal, the first information conveyed by a plurality of multiplexed frequency bands, individual ones of the multiplexed frequency bands corresponding to individual ones of first users and to a transport format, wherein detecting comprises making data decisions corresponding to the first information;
for each first user, creating a regenerated signal using the data decisions corresponding to that first user and the transport format;
creating a resultant signal based on the regenerated signals for all of the first users and on the received wideband signal; and
detecting second information in the resultant signal at least by using a plurality of spreading codes, individual ones of which are associated with individual ones of second users.

2. The method of claim 1, wherein creating a regenerated signal further comprises, for each first user, applying channel estimates to the regenerated signal corresponding to that first user.

3. The method of claim 1, wherein creating a resultant signal further comprises subtracting the regenerated signals for all of the first users from the received wideband signal to create the resultant signal.

4. The method of claim 3, wherein the method further comprises creating a single regenerated signal from all of the regenerated signals for all of the first users and subtracting the single regenerated signal from the received wideband signal to create the resultant signal.

5. The method of claim 1, wherein creating a resultant signal further comprises subtracting the regenerated signals for all of the first users from the received wideband signal to create the resultant signal.

6. The method of claim 1, wherein the second information occupies a first frequency band in the wideband signal and the first information occupies a second frequency band that at least partially overlaps the first frequency band.

7. The method of claim 1, wherein the transport format comprises a plurality of data blocks having cyclic prefixes and data portions and comprises a pilot data block comprising a cyclic prefix and a pilot signal.

8. The method of claim 1, wherein creating a regenerated signal further comprises, for each first user:
compressing a plurality of symbols in a symbol sequence corresponding to the data decisions into a symbol repetition block;
repeating the symbol repetition block a first predetermined number of times to create repeated symbols;
adding a cyclic prefix to the repeated symbols to create a data block;
performing compressing, repeating, and adding a second predetermined number of times in order to create a predetermined number of data blocks;
adding a pilot data block, comprising a pilot symbol and a cyclic prefix, to the data blocks; and
modulating the data blocks and the pilot data block using a user-specific phase vector to create the regenerated signal corresponding to that first user.

9. The method of claim 1, wherein the transport format is a first transport format, wherein detecting second information uses a second transport format, and wherein each of the first and second transport formats has a duration in a timeslot of ⅔ millisecond, includes 2560 chips used to store information, and is received using a chip rate of 3.84 million chips per second.

10. The method of claim 1, wherein detecting first information further comprises detecting undecoded bits and performing soft quantization on undecoded bits to make the data decisions.

11. The method of claim 1, wherein detecting first information further comprises decoding a portion of the wideband signal to create decoded bits and performing soft quantization on decoded bits to make the data decisions.

12. The method of claim 1, wherein detecting first information further comprises decoding a portion of the wideband signal to create decoded bits and performing hard quantization on the decoded bits to make the data decisions.

13. The method of claim 1, wherein each first user is assigned a different user-specific phase vector and detecting first information uses the user-specific phase vectors in order to determine to which user the first information belongs.

14. The method of claim 13, wherein each user-specific phase vector causes information transmitted by each user to occupy unique user-specific frequency bands in the multiplexed frequency bands and detecting first information uses the user-specific phase vectors to determine corresponding user-specific frequency bands.

15. A computer program product tangibly embodying a program of machine-readable instructions executable by at least one data processor to perform operations comprising:
detecting first information in a received wideband signal, the first information conveyed by a plurality of multiplexed frequency bands, individual ones of the multiplexed frequency bands corresponding to individual ones of first users and to a transport format, wherein detecting comprises making data decisions corresponding to the first information;
for each first user, creating a regenerated signal using the data decisions corresponding to that first user and the transport format;
creating a resultant signal based on the regenerated signals for all of the first users and on the received wideband signal; and
detecting second information in the resultant signal at least by using a plurality of spreading codes, individual ones of which are associated with individual ones of second users.

16. The computer program product of claim 15, wherein the operation of creating a resultant signal further comprises the operation of subtracting the regenerated signals for all of the first users from the received wideband signal to create the resultant signal.

17. The computer program product of claim 15, wherein the second information occupies a first frequency band in the wideband signal and the first information occupies a second frequency band that at least partially overlaps the first frequency band.

18. The computer program product of claim 15, wherein the operation of creating a regenerated signal further comprises the operations of, for each first user:
compressing a plurality of symbols in a symbol sequence corresponding to the data decisions into a symbol repetition block;
repeating the symbol repetition block a first predetermined number of times to create repeated symbols;
adding a cyclic prefix to the repeated symbols to create a data block;
performing compressing, repeating, and adding a second predetermined number of times in order to create a predetermined number of data blocks;
adding a pilot data block, comprising a pilot symbol and a cyclic prefix, to the data blocks;
modulating the data blocks and the pilot data block using a user-specific phase vector to create the regenerated signal corresponding to that first user; and
applying channel estimates to the regenerated signal corresponding to that first user.

19. The computer program product of claim 15, wherein the transport format is a first transport format, wherein the first transport format comprises a plurality of data blocks having cyclic prefixes and data portions and comprises a pilot data block comprising a cyclic prefix and a pilot signal, wherein the operation of detecting second information uses a second transport format, and wherein each transport format has a duration in a timeslot of ⅔ millisecond, includes 2560 chips used to store information, and is received using a chip rate of 3.84 million chips per second.

20. The computer program product of claim 15, wherein the operation of detecting first information further comprises the operations of detecting undecoded bits and performing soft quantization on undecoded bits to make the data decisions.

21. The computer program product of claim 15, wherein the operation of detecting first information further comprises the operations of decoding a portion of the wideband signal to create decoded bits and performing soft quantization on decoded bits to make the data decisions.

22. The computer program product of claim 15, wherein the operation of detecting first information further comprises the operation of decoding a portion of the wideband signal to create decoded bits and performing hard quantization on the decoded bits to make the data decisions.

23. The computer program product of claim 15, wherein each first user is assigned a different user-specific phase vector and the operation of detecting first information uses the user-specific phase vectors in order to determine to which user the first information belongs.

24. The computer program product of claim 23, wherein each user-specific phase vector causes information transmitted by each user to occupy unique user-specific frequency bands in the multiplexed frequency bands and the operation of detecting first information uses the user-specific phase vectors to determine corresponding user-specific frequency bands.

25. An apparatus comprising:
a first detector configured to detect first information in a received wideband signal, the first information conveyed by a plurality of multiplexed frequency bands, individual ones of the multiplexed frequency bands corresponding to individual ones of first users and to a transport format, wherein the first detector is configured, during detection, to make data decisions corresponding to the first information;
a regeneration module configured, for each first user, to create a regenerated signal using the data decisions corresponding to that first user and the transport format;
a device configured to create a resultant signal based on the regenerated signals for all of the first users and on the received wideband signal; and
a second detector configured to detect second information in the resultant signal at least by using a plurality of spreading codes, individual ones of which are associated with individual ones of second users.

26. The apparatus of claim 25, wherein the device configured to create the resultant signal further comprises an adder configured to subtract the regenerated signals for all of the first users from the received wideband signal to create the resultant signal.

27. The apparatus of claim 25, further comprising at least one antenna coupled to the first detector and the adder and configured to receive the wideband signal.

28. The apparatus of claim 25, wherein the first detector, regeneration modules, adder, and second detector are formed at least partially as part of at least one integrated circuit.

29. The apparatus of claim 25, wherein the second information occupies a first frequency band in the wideband signal and the first information occupies a second frequency band that at least partially overlaps the first frequency band.

30. The apparatus of claim 25, wherein:
the regeneration module further comprises:
a compression module configured to compress a plurality of symbols in a symbol sequence corresponding to the data decisions for at least one of the first users into a symbol repetition block;
a repetition module configured to repeat the symbol repetition block a first predetermined number of times to create repeated blocks;
a cyclic prefix addition module configured to add a cyclic prefix to the repeated blocks to create a data block, wherein the compression module, repetition module, and cyclic prefix addition module operate in order to create a predetermined number of data blocks;
a pilot addition module configured to add a pilot data block, comprising a pilot symbol and a cyclic prefix, to the data blocks; and
a modulation module configured to modulate the data blocks and the pilot data block with at least one user-specific phase vector to create a regenerated signal corresponding to the at least one first user; and
the regeneration module is further configured to apply channel estimates to the regenerated signal corresponding to the at least one first user.

31. The apparatus of claim 30, wherein the regeneration module is configured to operate the compression module, repetition module, cyclic prefix module, pilot addition module, and modulation module for each of the first users to create the first information corresponding to each of the first users.

32. The apparatus of claim 30, wherein each of the compression module, repetition module, cyclic prefix module, pilot addition module, and modulation module operates on data corresponding to all of the first users to create first information corresponding to all of the first users.

33. The apparatus of claim 25, wherein the transport format is a first transport format, wherein the first transport format comprises a plurality of data blocks having cyclic prefixes and data portions and comprises a pilot data block comprising a cyclic prefix and a pilot signal, wherein the second detector is configured to us a second transport format, and wherein each transport format has a duration in a timeslot of ⅔ millisecond, includes 2560 chips used to store information, and is received using a chip rate of 3.84 million chips per second.

34. The apparatus of claim 25, wherein the first detector comprises a receiver configured to create undecoded bits from the wideband signal and comprises a soft quantizer configured to perform soft quantization on the undecoded bits to make the data decisions.

35. The apparatus of claim 25, wherein the first detector comprises a receiver configured to create undecoded bits from the wideband signal, wherein the first detector comprises a decoder configured to create decoded bits from the undecoded bits, and wherein the first detector further comprises a soft quantizer configured to perform soft quantization on the decoded bits to make the data decisions.

36. The apparatus of claim 25, wherein the first detector comprises a receiver configured to create undecoded bits from the wideband signal, wherein the first detector comprises a decoded configured to create decoded bits from the undecoded bits, and wherein the first detector comprises a hard quantizer configured to perform hard quantization on the decoded bits to make the data decisions.

37. The apparatus of claim 25, wherein each first user is assigned a different user-specific phase vector and detecting information in the wideband signal corresponding to a plurality of multiplexed frequency bands uses the user-specific phase vectors.

38. An apparatus comprising:
means for detecting first information in a received wideband signal, the first information conveyed by a plurality of multiplexed frequency bands, individual ones of the multiplexed frequency bands corresponding to individual ones of first users and to a transport format, wherein the means for detecting first information is configured, during detection, to make data decisions corresponding to the first information;
means for creating, for each first user, a regenerated signal using the data decisions corresponding to that first user and the transport format;
means for creating a resultant signal based on the regenerated signals for all of the first users and on the received wideband signal; and
means for detecting second information in the resultant signal at least by using a plurality of spreading codes, individual ones of which are associated with individual ones of second users.

39. The apparatus of claim 38, wherein the second information occupies a first frequency band in the wideband signal and the first information occupies a second frequency band that at least partially overlaps the first frequency band.
